(19) United States
(12) Patent Application Publication
(10) Pub. No.: US 2026/0280630 A1
(43) Pub. Date: Sep. 17, 2026

(54) RECIPROCITY-AIDED INTERFERENCE SUPPRESSION VIA EIGEN BEAMFORMING

(71) Applicant: Telefonaktiebolaget LM Ericsson (publ), Stockholm (SE)

(72) Inventors: Amr EL-KEYI, Kanata, Ontario (CA); Chandra BONTU, Nepean, Ontario (CA)

(73) Assignee: Telefonaktiebolaget LM Ericsson (publ), Stockholm (SE)

(21) Appl. No.: 18/875,709

(22) PCT Filed: Jul. 12, 2022
(86) PCT No.: PCT/IB2022/056430

§ 371 Date: Dec. 16, 2024

(51) Int. Cl. H04B 7/06; H04B 7/0456; H04J 11/00; H04L 25/03

(52) U.S. Cl. CPC H04B 7/0617; H04B 7/0456; H04J 11/005; H04L 25/03343; H04L 25/0391

(57) ABSTRACT

A method and network node for reciprocity-aided interference suppression via eigen beamforming are disclosed. According to one aspect, a method includes determining an L×M channel matrix by selecting L rows of an N×M channel matrix or L linear combinations of rows of the N×M channel matrix, M being a number of antennas for downlink transmissions, N being a number of wireless device receiving antennas, L being a number of layers. The method also includes determining an M×M preprocessing matrix based on an eigen-decomposition of an M×M interference covariance matrix. The method further includes determining an M×L RAIT precoder matrix based on an inverse of an L×L matrix, the L×L matrix being based on a first matrix product of the L×M channel matrix, the M×M preprocessing matrix and an M×L Hermitian transpose of the L×M channel matrix.

### TECHNICAL FIELD

The present disclosure relates to wireless communications, and in particular, to reciprocity-aided interference suppression via eigen beamforming to address inter-cell interference.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Managing inter-cell interference can significantly increase the throughput of cellular systems especially in dense deployment scenarios. For multiple input multiple output (MIMO) systems, downlink inter-cell interference management can be accomplished by designing the downlink precoders such that the transmitted power is reduced in the spatial directions of the users in adjacent cells. A closed-form solution for maximizing the signal to leakage-plus-noise ratio (SLNR) has been proposed for designing interference-aware downlink precoders by using the estimate of the channel to the target receiver and the interference covariance matrix.

Legacy implementation for interference-aware downlink precoder calculation requires inversion of the interference covariance matrix whose dimension is equal to the number of antennas at the base station. For active antenna systems (AAS) with large number of antennas, e.g., AIR 6488, the computational complexity of this matrix inversion might be too high for practical implementation.

### SUMMARY

Some embodiments advantageously provide methods and network nodes for reciprocity-aided interference suppression via eigen beamforming.

Some embodiments provide an alternate implementation for interference-aware downlink precoder calculation that has significantly less computational complexity compared to legacy solutions. The proposed implementation utilizes a subset of the Eigen vectors and corresponding Eigen values of the interference covariance matrix to construct a channel pre-processing matrix that is used to steer the downlink transmission away from the directions causing interference to users in the neighbor cells. In some embodiments, a precoder is implemented by multiplying the downlink channel estimates of the WDs in a desired cell by the pre-processing matrix. Hence, interference leakage reduction may be accomplished without the need for full-dimension interference covariance matrix inversion. The proposed implementation can provide tunable interference leakage reduction based on the number of Eigen vectors utilized in constructing the channel pre-processing matrix.

Some embodiments include an interference-aware downlink precoding algorithm that utilizes a subset of the eigen vectors and the associated eigen values of the interference covariance matrix to reduce out-of-cell interference leakage to neighbor cells.

Some embodiments include a method at a network node comprising:
Measuring signals received from users in the co-channel cells at the network node antenna ports in a transmission time interval (TTI);
Computing the spatial covariance matrix of the measured signals;
Computing a pre-processing matrix based on the spatial covariance matrix;
Estimating the MIMO channel of a user in the cell transmitting in the TTI for selected transmission rank;
Transforming the estimated channel using the preprocessing matrix; and/or
Computing a downlink (DL) precoder using the transformed channel matrix.

Some embodiments provide a low complexity implementation (as compared with other possible solutions) for downlink interference-aware precoding that avoids inversion of the full-dimension interference covariance matrix. In particular, some embodiments use a subset of the Eigen vectors and the corresponding Eigen values of the interference covariance matrix to construct a downlink precoder that can suppress downlink intercell interference.

According to one aspect, a method in a network node configured to determine a reciprocity-aided interference aware transmission, RAIT, precoder matrix for precoding downlink transmissions to a wireless (WD) is provided. The method includes determining an L×M channel matrix by one of: selecting L rows of an N×M channel matrix, and selecting L linear combinations of rows of the N×M channel matrix, M being a number of antennas at the network node to be used for the downlink transmissions, N being a number of receiving antennas at the WD, L being an integer less than M. The method also includes determining an M×M preprocessing matrix based at least in part on an eigen-decomposition of an M×M interference covariance matrix. The method further includes determining an M×L RAIT precoder matrix based at least in part on an inverse of an L×L matrix, the L×L matrix being based at least in part on a first matrix product of the L×M channel matrix, the M×M preprocessing matrix and an M×L Hermitian transpose of the L×M channel matrix.

In some embodiments, the method also includes further comprising determining an M×M eigenvector matrix and M associated eigenvalues based at least in part on the eigen-decomposition of the M×M interference covariance matrix, each of the M associated eigenvalues being representative of an interference power and each eigenvector of the M×M eigenvector matrix being representative of a different direction of propagation of the interference power. In some embodiments, the M×M preprocessing matrix is based at least in part on an estimated noise power associated with a subset of M−K eigenvectors of the M×M interference covariance matrix, K being an integer less than M. In some embodiments, the estimated noise power per dimension is based at least in part on a difference between a first trace of the M×M interference covariance matrix and a second trace of a K×K diagonal matrix of eigenvalues corresponding to K selected eigenvectors of the M×M eigenvector matrix. In some embodiments, the K selected eigenvectors are selected so that a sum of the corresponding eigenvalues is a specified fraction of a total interference power. In some embodiments, the K selected eigenvectors correspond to the set of K largest eigenvalues. In some embodiments, L is a number of transmission layers less than or equal to the number of receiving antennas at the WD. In some embodiments, the M×L RAIT precoder matrix is determined based at least in part on a second matrix product of the M×M preprocessing matrix, the M×L Hermitian transpose of the L×M channel matrix and the inverse of the L×L matrix. In some embodiments, the M×M preprocessing matrix is based at least in part on a third matrix product of an M×K matrix of selected eigenvectors, a K×K diagonal modified eigenvalue matrix, and the K×M the Hermitian transpose of the M×K selected eigenvector matrix, K being an integer less than M. In some embodiments, the M×M preprocessing matrix is determined at least in part by computing:

$$V ( f , t ) = \overline{y} ( f , t ) {I}_{M} - \tilde{E} ( f , t ) \tilde{Y} ( f , t ) {\tilde{E}}^{{}_{H}} ( f , t )$$

where V(f,t) is the M×M preprocessing matrix,

$$\overline{y} ( f , t ) = \frac{{δ}^{2}}{\overline{σ} ( f , t ) + {δ}^{2}} ,$$

I_{M} is an M×M identity matrix, \tilde{E}(f,t) is an M×K matrix of K selected eigenvectors from the eigen vectors of the M×M interference covariance matrix, \tilde{Y}(f,t) is a K×K diagonal matrix with the it element given by

$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} ,$$

δ² is a minimum mean square error regularization factor, σᵢ(f,t) is a noise power associated with the i^{th} eigenvector of the M×M interference covariance matrix,

$$\overline{σ} ( f , t ) = \frac{tr \{ Λ ( f , t ) \} - tr \{ \tilde{Σ} ( f , t ) \}}{M - K} ,$$

is an estimated noise power per tr{Λ(f,t)} is the trace of the interference covariance matrix and tr{\tilde{Σ}(f,t)} is the trace of a K×K matrix of dominant eigenvalues corresponding to the K selected eigenvectors.

According to another aspect, a network node configured to determine a reciprocity-aided interference aware transmission, RAIT, precoder matrix for precoding downlink transmissions to a wireless, WD, is provided. The network node includes processing circuitry configured to: determine an L×M channel matrix by one of: selecting L rows of an N×M channel matrix, and selecting L linear combinations of rows of the N×M channel matrix, M being a number of antennas at the network node to be used for the downlink transmissions, N being a number of receiving antennas at the WD, L being an integer less than M. The processing circuitry is further configured to determine an M×M preprocessing matrix based at least in part on an eigen-decomposition of an M×M interference covariance matrix. The processing circuitry is also configured to determine an M×L RAIT precoder matrix based at least in part on an inverse of an L×L matrix, the L×L matrix being based at least in part on a first matrix product of the L×M channel matrix, the M×M preprocessing matrix and an M×L Hermitian transpose of the L×M channel matrix.

According to this aspect, in some embodiments, the processing circuitry is further configured to determine an M×M eigenvector matrix and M associated eigenvalues based at least in part on the eigen-decomposition of the M×M interference covariance matrix, each of the M associated eigenvalues being representative of an interference power and each eigenvector of the M×M eigenvector matrix being representative of a different direction of propagation of the interference power represented by the corresponding eigenvalue. In some embodiments, the M×M preprocessing matrix is based at least in part on an estimated noise power associated with a subset of M−K eigenvectors of the M×M eigenvector matrix, K being an integer less than M. In some embodiments, the estimated noise power per dimension is based at least in part on a difference between a first trace of the M×M interference covariance matrix and a second trace of a K×K diagonal matrix of eigenvalues corresponding to K selected eigenvectors of the M×M eigenvector matrix. In some embodiments, the K selected eigenvectors are selected so that a sum of the corresponding eigenvalues is a specified fraction of a total interference power. In some embodiments, the K selected eigenvectors correspond to a set of K largest eigenvalues. In some embodiments, L is a number of transmission layers less than or equal to the number of receiving antennas at the WD. In some embodiments, the M×L RAIT precoder matrix is determined based at least in part on a second matrix product of the M×M preprocessing matrix, the M×L Hermitian transpose of the L×M channel matrix and the inverse of the L×L matrix. In some embodiments, the M×M preprocessing matrix is based at least in part on a third matrix product of an M×K matrix of selected eigenvectors, a K×K diagonal modified eigenvalue matrix, and an K×M Hermitian transpose of the M×K eigenvector matrix, K being an integer less than M. In some embodiments, the M×M preprocessing matrix is determined at least in part by computing:

$$V ( f , t ) = \overline{y} ( f , t ) {I}_{M} - \tilde{E} ( f , t ) \tilde{Y} ( f , t ) {\tilde{E}}^{{}_{H}} ( f , t )$$

where V(f,t) is the M×M preprocessing matrix,

$$\overline{y} ( f , t ) = \frac{{δ}^{2}}{\overline{σ} ( f , t ) + {δ}^{2}} ,$$

I_{M} is an M×M identity matrix, \tilde{E}(f,t) is an M×K matrix of K selected eigenvectors from the M×M interference covariance matrix, \tilde{Y}(f,t) is a K×K diagonal matrix with the i^{th} element given by

$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} ,$$

δ2 is a minimum mean square error regularization factor, σᵢ(f,t) is a noise power associated with the it eigenvector of the M×M interference covariance matrix,

$$\overline{σ} ( f , t ) = \frac{tr \{ Λ ( f , t ) \} - tr \{ \tilde{Σ} ( f , t ) \}}{M - K} ,$$

is in estimated noise power per dimension, tr{Λ(f,t)} is the trace of the interference covariance matrix and tr{\tilde{Σ}(f,t)} is the trace of a K×K matrix of dominant eigenvalues corresponding to the K selected eigenvectors.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for reciprocity-aided interference suppression via eigen beamforming according to principles set forth herein;

FIG. 8 is a block diagram of a RAIT precoder unit constructed according to principles disclosed herein; and

FIG. 9 is graph of an example of cell throughput versus number of eigenvectors used in the RAIT precoder unit to determine the RAIT precoder unit of FIG. 8.

### DETAILED DESCRIPTION

Before describing in detail example embodiments, it is noted that the embodiments reside primarily in combinations of apparatus components and processing steps related to reciprocity-aided interference suppression via eigen beamforming. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

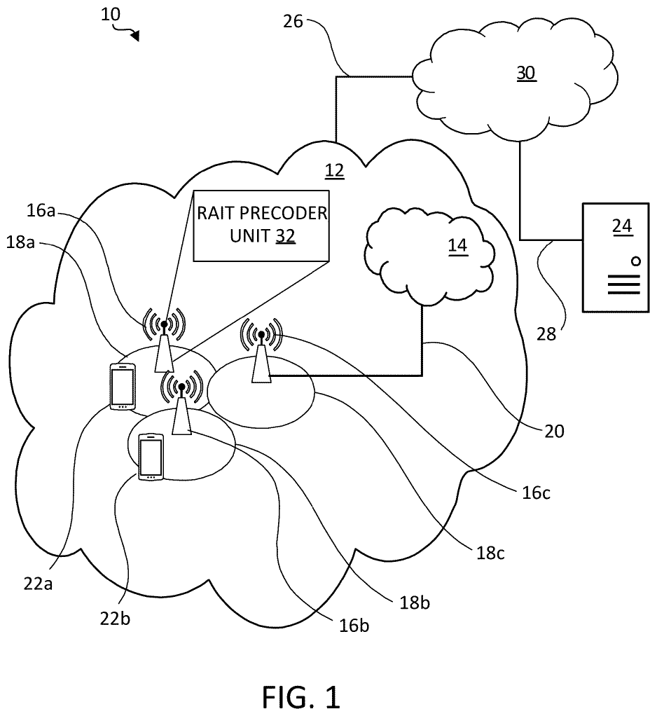

Some embodiments provide reciprocity-aided interference suppression via eigen beamforming. Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a reciprocity-aided interference-aware transmission (RAIT) precoder unit 32 which is configured to determine a RAIT precoder based at least in part on an eigen decomposition of an M×M interference covariance matrix to determine an M×M preprocessing matrix and an inversion of an L×L matrix, the L×L matrix being a product of an L×M channel matrix, the M×M preprocessing matrix and the M×L Hermitian transpose of the L×M channel matrix.

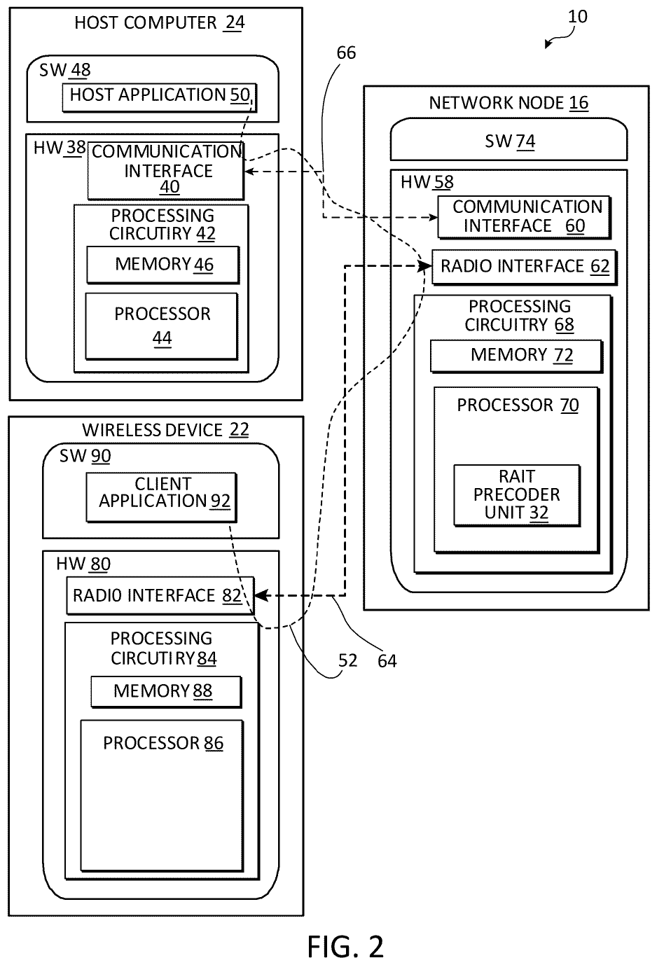

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a reciprocity-aided interference-aware transmission (RAIT) precoder unit 32 which is configured to determine a RAIT precoder based at least in part on an eigen decomposition of an M×M interference covariance matrix to determine an M×M preprocessing matrix and an inversion of an L×L matrix, the L×L matrix being a product of an L×M channel matrix, the M×M preprocessing matrix and the M×L Hermitian transpose of the L×M channel matrix.

The communication system 10 further includes the WD 22 already referred to. The WD 22 may have hardware 80 that may include a radio interface 82 configured to set up and maintain a wireless connection 64 with a network node 16 serving a coverage area 18, e.g., a cell, in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as RAIT precoder unit 32, as being within a respective processor, it is contemplated that these units may be implemented such that a portion of the unit is stored in a corresponding memory within the processing circuitry. In other words, the units may be implemented in hardware or in a combination of hardware and software within the processing circuitry.

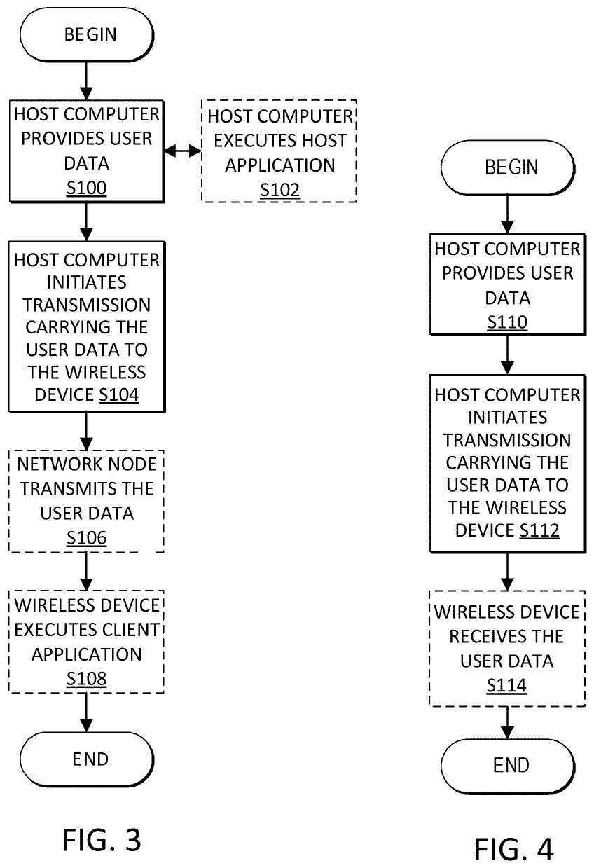

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

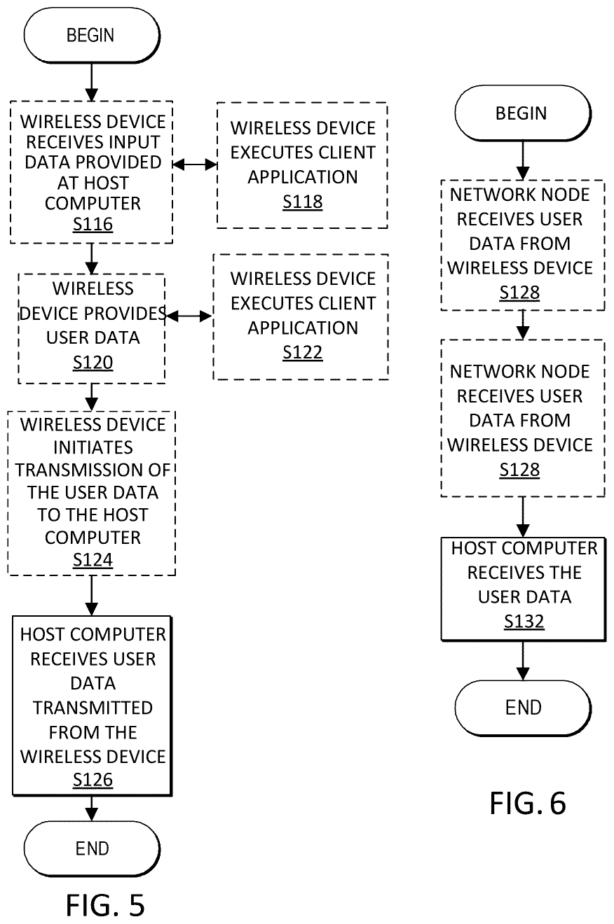

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

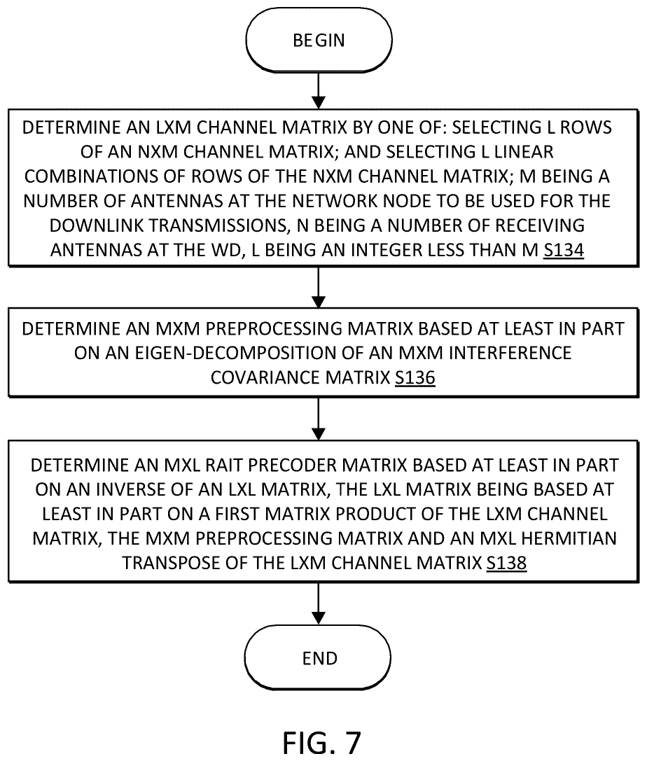

FIG. 7 is a flowchart of an example process in a network node 16 for reciprocity-aided interference suppression via eigen beamforming. One or more blocks described herein may be performed by one or more elements of network node 16 such as by one or more of processing circuitry 68 (including the RAIT precoder unit 32), processor 70, radio interface 62 and/or communication interface 60. Network node 16 such as via processing circuitry 68 and/or processor 70 and/or radio interface 62 and/or communication interface 60 is configured to: determine an L×M channel matrix by one of: selecting L rows of an N×M channel matrix, and selecting L linear combinations of rows of the N×M channel matrix, M being a number of antennas at the network node to be used for the downlink transmissions, N being a number of receiving antennas at the WD, L being an integer less than M (Block S134). The process also includes determining an M×M preprocessing matrix based at least in part on an eigen-decomposition of an M×M interference covariance matrix (Block S136). The process further includes determining an M×L RAIT precoder matrix based at least in part on an inverse of an L×L matrix, the L×L matrix being based at least in part on a first matrix product of the L×M channel matrix, the M×M preprocessing matrix and an M×L Hermitian transpose of the L×M channel matrix (Block S138).

In some embodiments, the method also includes further comprising determining an M×M eigenvector matrix and M associated eigenvalues based at least in part on the eigen-decomposition of the M×M interference covariance matrix, each of the M associated eigenvalues being representative of an interference power and each eigenvector of the M×M eigenvector matrix being representative of a different direction of propagation of the interference power. In some embodiments, the M×M preprocessing matrix is based at least in part on an estimated noise power associated with a subset of M−K eigenvectors of the M×M interference covariance matrix, K being an integer less than M. In some embodiments, the estimated noise power per dimension is based at least in part on a difference between a first trace of the M×M interference covariance matrix and a second trace of a K×K diagonal matrix of eigenvalues corresponding to K selected eigenvectors of the M×M eigenvector matrix. In some embodiments, the K selected eigenvectors are selected so that a sum of the corresponding eigenvalues is a specified fraction of a total interference power. In some embodiments, the K selected eigenvectors correspond to the set of K largest eigenvalues. In some embodiments, L is a number of transmission layers less than or equal to the number of receiving antennas at the WD. In some embodiments, the M×L RAIT precoder matrix is determined based at least in part on a second matrix product of the M×M preprocessing matrix, the M×L Hermitian transpose of the L×M channel matrix and the inverse of the L×L matrix. In some embodiments, the M×M preprocessing matrix is based at least in part on a third matrix product of an M×K matrix of selected eigenvectors, a K×K diagonal modified eigenvalue matrix, and the K×M the Hermitian transpose of the M×K selected eigenvector matrix, K being an integer less than M. In some embodiments, the M×M preprocessing matrix is determined at least in part by computing:

$$V ( f , t ) = \overline{y} ( f , t ) {I}_{M} - \tilde{E} ( f , t ) \tilde{Y} ( f , t ) {\tilde{E}}^{{}_{H}} ( f , t )$$

where V(f,t) is the M×M preprocessing matrix,

$$\overline{y} ( f , t ) = \frac{{δ}^{2}}{\overline{σ} ( f , t ) + {δ}^{2}} ,$$

I_{M} is an M×M identity matrix, \tilde{E}(f,t) is an M×K matrix of K selected eigenvectors from the eigen vectors of the M×M interference covariance matrix, \tilde{Y}(f,t) is a K×K diagonal matrix with the it element given by

$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} ,$$

δ² is a minimum mean square error regularization factor, σᵢ(f,t) is a noise power associated with the i^{th} eigenvector of the M×M interference covariance matrix,

$$\overline{σ} ( f , t ) = \frac{tr \{ Λ ( f , t ) \} - tr \{ \tilde{Σ} ( f , t ) \}}{M - K} ,$$

is an estimated noise power per dimension, tr{Λ(f,t)} is the trace of the interference covariance matrix and tr{\tilde{E}(f,t)} is the trace of a K×K matrix of dominant eigenvalues corresponding to the K selected eigenvectors.

Having described the general process flow of arrangements of the disclosure and having provided examples of hardware and software arrangements for implementing the processes and functions of the disclosure, the sections below provide details and examples of arrangements for reciprocity-aided interference suppression via eigen beamforming.

### System Model

Consider a network node 16, e.g., base station, employing an M-element antenna array communicating with a WD 22 equipped with N receive antennas. Let the N×M matrix H(f,t) denote the matrix containing the coefficients of the downlink channel from the base station to the WD 22 at frequency f and time instant t. In time-division duplex (TDD) systems where channel reciprocity can be assumed, the channel estimates are available at the base station, e.g., from uplink channel sounding transmissions, and are used to select the precoding coefficients to transmit downlink data. The channel estimates can also be obtained using quantized feedback from the WD 22 to be used by the base station in downlink precoding, e.g., Type 1 and Type 2 codebook-based beamforming in NR.

The network node 16, e.g., base station, utilizes an M×L precoding matrix \tilde{W}(f,t) to transmit L≤min{M,N} spatial layers (streams) to the WD 22. Assume that the matrix \tilde{W}(f,t) is normalized such that

$${\tilde{w}}_{i}^{H} ( f , t ) {\tilde{w}}_{i} ( f , t ) = 1 / L$$

for i=1, . . . , L where \tilde{w}ᵢ(f,t) denotes the ith column of the matrix \tilde{W}(f,t) and ( )^{H} denotes the Hermitian transpose of a matrix. The N×1 received signal vector at the WD 22 is given by:

$$y ( f , t ) = H ( f , t ) \tilde{W} ( f , t ) A ( f , t ) u ( f , t ) + n ( f , t )$$

where u(f,t)=[u₀(f,t) . . . u_{L-1}(f,t)]T is the L×1 vector containing the transmitted symbols on the L spatial layers, ( )^{T} denotes the transpose of a matrix, the L×L diagonal matrix A(f,t) is given by A(f,t)=diag{\sqrt{p₀}, \sqrt{p₂}, . . . , \sqrt{p_{L-1}}}, pᵢ is the power allocated to the ith layer, and n(f,t) is the received interference-plus-noise at the WD 22.

### Reciprocity-Aided Transmission

The precoding matrix \tilde{W}_{RAT}(f,t) can be selected based on a minimum mean square error (MMSE) design criterion. The reciprocity-aided transmission (RAT) precoder is computed by calculating the unnormalized precoder \tilde{W}_{RAT}(f,t) as

$${W}_{R A T} ( f , t ) = {\tilde{H}}^{{}_{H}} ( f , t ) {( \tilde{H} ( f , t ) {\tilde{H}}^{{}_{H}} ( f , t ) + {δ}^{2} ( f , t ) {I}_{L} )}^{- 1}$$

where δ²(f,t) is the MMSE regularization factor, I_{L} is the L×L identity matrix, and \tilde{H}(f,t) the L×M matrix corresponding to the downlink channel after port mixing/selection. The selected channel matrix \tilde{H}(f,t) can be constructed by selecting some rows of the full dimension downlink channel \tilde{H}(f,t) based on some selection criterion, e.g., by selecting the rows with the highest norm. Alternatively, the selected channel matrix \tilde{H}(f,t) can be constructed by mixing the rows of the full dimension channel H(f,t), i.e., \tilde{H}(f,t)=S(f,t) \tilde{H}(f,t) where S(f,t) is the L×N port mixing matrix. The rank-L MMSE precoder is given by \tilde{W}_{RAT}(f,t) and obtained from the matrix W_{RAT}(f,t) by scaling each of its columns such that its norm is equal to.

$$\frac{1}{\sqrt{L}} .$$

### Reciprocity-Aided Interference-Aware Transmission

In dense deployment scenarios, where the network nodes 16, e.g., base stations, are closely located, the WD 22 might receive significant interference from downlink transmissions of neighbor network nodes 16, e.g., base stations, that causes a large reduction in downlink throughput, especially for WDs 22 that are located on the coverage area 18, e.g., cell, edge the network node 16. Interference-aware downlink transmission schemes design the precoding matrix such that the received signal power at the target WD 22 is maximized while controlling the interference caused at the WDs 22 in the neighbor cells.

Let the M×M matrix Λ(f,t) denote the downlink interference covariance matrix, i.e., the covariance of the downlink channel vector to out-of-cell WDs 22. In time-division duplex (TDD) systems, the matrix Λ(f,t) can be estimated from the received uplink signal at sounding transmission times, e.g., by subtracting the expected received signal vector of sounding sequences transmitted by cell-attached WDs 22 from the received uplink signal vector. This results in samples of the out-of-cell interference vector. The interference covariance matrix is then obtained by calculating the second-order statistics of the out-of-cell interference vector samples.

The reciprocity-aided interference-aware transmission (RAIT) precoder may be computed by calculating the unnormalized precoder W_{RAIT}(f,t) as

$${W}_{RAIT} ( f , t ) = {( {\tilde{H}}^{H} ( f , t ) \tilde{H} ( f , t ) + Λ ( f , t ) + {δ}^{2} ( f , t ) {I}_{M} )}^{- 1} {\tilde{H}}^{H} ( f , t )$$

and the normalized RAIT precoder \tilde{W}_{RAIT}(f,t) is obtained from W_{RAIT}(f,t) by scaling each of its columns such that its norm is equal to

$$\frac{1}{\sqrt{L}} .$$

### Eigen Beamforming Reciprocity-Aided Interference-Aware Transmission

Let the Eigen decomposition of the interference covariance matrix Λ(f,t) be given by Λ(f,t)=E(f,t) Σ(f,t) E^{H}(f,t) where E(f,t) is the M×M matrix containing the eigen vectors of Λ(f,t) and Σ(f,t) is the M×M diagonal matrix containing the corresponding eigen values on its main diagonal. The unnormalized Eigen RAIT precoder can be computed by the RAIT precoder unit 32 by considering the (L+M)×M combined channel plus interference eigen vectors

$${\tilde{H}}_{H + I} ( f , t ) = [ \begin{matrix}\tilde{H} ( f , t ) \\ {Σ}^{\frac{1}{2}} ( f , t ) {E}^{H} ( f , t )\end{matrix} ]$$

and computing the first L layers of the corresponding unnormalized RAT precoder, i.e.:

$${W}_{RAIT , EIG} ( f , t ) = \tilde{ℋ} \{ {\tilde{H}}_{H + I}^{H} ( f , t ) {( {\tilde{H}}_{H + I} ( f , t ) {\tilde{H}}_{H + I}^{H} ( f , t ) + {δ}^{2} {I}_{L + M} )}^{- 1} \}$$

where the operator [symbol] {.} selects the first L columns of a matrix. The normalized eigen precoder W_{RAIT,EIG}(f,t) may be obtained from W_{RAIT,EIG}(f,t) by scaling each column such that its norm is equal to

$$\frac{1}{\sqrt{L}} .$$

Note that the above expression can be computed for only the first L columns of the inverse of the matrix

$${\tilde{H}}_{H + I} ( f , t ) {\tilde{H}}_{H + I}^{H} ( f , t ) + {δ}^{2} {I}_{L + M}$$

which is an (L+M)×(L+M) matrix. This matrix inversion can be avoided by exploiting the fact that

$${\tilde{H}}_{H + I} ( f , t ) {\tilde{H}}_{H + I}^{H} ( f , t ) + {δ}^{2} {I}_{L + M}$$

may be structured as:

$${\tilde{H}}_{H + I} ( f , t ) {\tilde{H}}_{H + I}^{H} ( f , t ) + {δ}^{2} {I}_{L + M} = [ \begin{matrix}\tilde{H} ( f , t ) {\tilde{H}}^{H} ( f , t ) + {δ}^{2} {I}_{L} & \tilde{H} ( f , t ) E ( f , t ) {Σ}^{\frac{1}{2}} ( f , t ) \\ {Σ}^{\frac{1}{2}} ( f , t ) {E}^{H} ( f , t ) {\tilde{H}}^{H} ( f ) & Σ ( f , t ) + {δ}^{2} {I}_{M}\end{matrix} ]$$

Then, the following identity for the inverse of a Hermitian 2×2 block matrix may be used:

$${[ \begin{matrix}A & B \\ {B}^{H} & D\end{matrix} ]}^{- 1} = [ \begin{matrix}{( A - B {D}^{- 1} {B}^{H} )}^{- 1} & - {( A - B {D}^{- 1} {B}^{H} )}^{- 1} B {D}^{- 1} \\ - {D}^{- 1} {{B}^{H} ( A - B {D}^{- 1} {B}^{H} )}^{- 1} & {D}^{- 1} + {D}^{- 1} {{B}^{H} ( A - B {D}^{- 1} {B}^{H} )}^{- 1} {BD}^{- 1}\end{matrix} ] .$$

By applying the above matrix identity on

$${( {\tilde{H}}_{H + I} ( f , t ) {\tilde{H}}_{H + I}^{H} ( f , t ) + {δ}^{2} {I}_{L + M} )}^{- 1}$$

and considering that only the first L columns of the matrix inverse need to be computed due to the operator [symbol] ,the Eigen precoder W_{RAIT,EIG}(f,t) can be written as:

$${W}_{RAIT , EIG} ( f , t ) = [ \begin{matrix}{\tilde{H}}^{H} ( f , t ) & E ( f , t ) {Σ}^{\frac{1}{2}} ( f , t )\end{matrix} ] [ \begin{matrix}{( \tilde{H} ( f , t ) ( {I}_{M} - E ( f , t ) X ( f , t ) {E}^{H} ( f , t ) ) {\tilde{H}}^{H} ( f , t ) + {δ}^{2} {I}_{L} )}^{- 1} \\ - {Σ}^{\frac{- 1}{2}} ( f , t ) X ( f , t ) {E}^{H} ( f , t ) {\tilde{H}}^{H} ( f , t ) {( \tilde{H} ( f , t ) ( {I}_{M} - E ( f , t ) X ( f , t ) {E}^{H} ( f , t ) ) {\tilde{H}}^{H} ( f , t ) + {δ}^{2} {I}_{L} )}^{- 1}\end{matrix} ]$$

where

$$X ( f , t ) = {Σ}^{\frac{1}{2}} ( f , t ) {( Σ ( f , t ) + {δ}^{2} {I}_{M} )}^{- 1} {Σ}^{\frac{1}{2}} ( f , t )$$

is an M×M diagonal matrix with the ith diagonal element given by

$${X}_{i , i} ( f , t ) = \frac{{σ}_{i} ( f , t )}{{σ}_{i} ( f , t ) + {δ}^{2}}$$

and λᵢ(f,t) is the ith eigen value of Λ(f,t).

W_{RAIT,EIG}(f,t) can be further simplified as;

$${W}_{RAIT , EIG} ( f , t ) = V ( f , t ) {\tilde{H}}^{H} ( f , t ) {( \tilde{H} ( f , t ) V ( f , t ) {\tilde{H}}^{H} ( f , t ) + {δ}^{2} {I}_{L} )}^{- 1}$$

where the M×M matrix V(f,t)=I_{M}−E(f,t)X(f,t)E^{H}(f,t), and hence, the matrix inversion may be performed for an L×L matrix.

### Computation of the Eigen Vectors

Even though computing the Eigen RAIT beamformer, W_{RAIT,EIG}(f,t), can be determined with inversion of an L×L matrix, computing the full Eigen value decomposition of the M×M matrix Λ(f,t) to estimate the M Eigen vectors in E(f,t) and the associated eigen values in Σ(f,t) requires more computations than my be necessary. The computational complexity can significantly be reduced by exploiting the fact that in typical dense deployments the interference covariance matrix is spatially colored, and that the interference typically lies in a reduced-dimension signal subspace.

Let \tilde{E}(f,t) denote the M×K matrix containing the dominant K Eigen vectors of the matrix Λ(f,t) and \tilde{Σ}(f,t) denote the K×K matrix containing the corresponding Eigen values. The dominant eigen vectors can be selected such that the sum of the corresponding eigen values contains a given fraction of the total interference power, e.g., 90% of the total interference power. Let Ē(f,t) denote the M×(M−K) matrix containing the remaining eigen vectors and Ē(f,t) denote the (M−K)×(M−K) diagonal matrix containing the corresponding Eigen values on the main diagonal, i.e.:

$$E ( f , t ) = [ \begin{matrix}\tilde{E} ( f , t ) & \overline{E} ( f , t )\end{matrix} ]$$

$$Σ ( f , t ) = diag \{ \begin{matrix}\tilde{Σ} ( f , t ) , & \overline{Σ} ( f , t )\end{matrix} \} .$$

Assume that Ē(f,t) contains the noise subspace, and hence, Σ̅(f,t)=6(f,t) I_{M-K}, where σ̅(f,t) is the noise power per-dimension and may be estimated as:

$$\overline{σ} ( f , t ) = \frac{tr \{ Λ ( f , t ) \} - t r \{ \tilde{Σ} ( f , t ) \}}{M - K} .$$

where tr{.} denotes the trace of a matrix. Using the above decomposition of E(f,t) and Σ(f,t), the expression holds:

$$E ( f , t ) X ( f , t ) E ( f , t ) = \tilde{E} ( f , t ) \tilde{X} ( f , t ) {\tilde{E}}^{H} ( f , t ) + \frac{\overline{σ} ( f , t )}{\overline{σ} ( f , t ) + {δ}^{2}} ( {I}_{M} - \tilde{E} ( f , t ) {\tilde{E}}^{H} ( f , t ) )$$

where use is made of the diagonal structure of the matrix X(f,t) and the fact that

$$\overline{E} ( f , t ) {\overline{E}}^{H} ( f , t ) = {I}_{M} - \tilde{E} ( f , t ) {\tilde{E}}^{H} ( f , t ) .$$

Therefore, the matrix V(f,t) in the above expression for W_{RAIT,EIG}(f,t) can be written as:

$$V ( f , t ) = \overline{y} ( f , t ) {I}_{M} - \tilde{E} ( f , t ) \tilde{Y} ( f , t ) {\tilde{E}}^{H} ( f , t )$$

where

$$\overline{y} ( f , t ) = \frac{{δ}^{2}}{\overline{σ} ( f , t ) + {δ}^{2}}$$

and \tilde{Y}(f,t) is the K×K diagonal matrix whose i th diagonal element is given by

$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} .$$

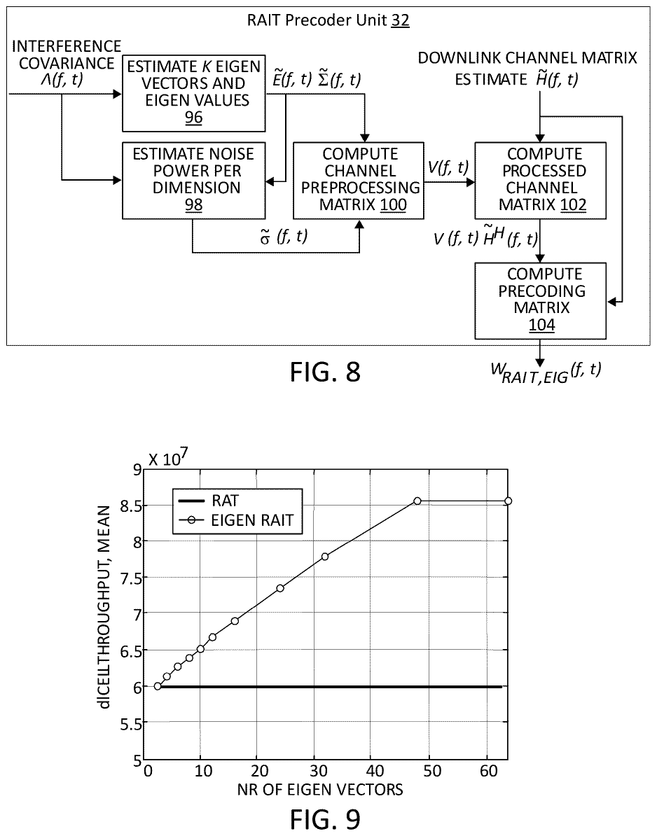

FIG. 8 shows a block diagram of one example of a RAIT precoder unit 32 for determining a RAIT precoder. The example of the RAIT precoder unit 32 shown in FIG. 8 includes an eigenvector estimation unit 96 to estimate K eigenvectors and corresponding eigenvalues based on an eigen decomposition of an. A noise power estimation unit 98 estimates the noise power per dimension, σ̅(f,t). The preprocessing matrix unit 100 determines the channel preprocessing matrix, V(f,t). A channel matrix unit 102 receives the downlink channel matrix \tilde{H}(f,t) and the preprocessing matrix V(f,t) and determines a processed channel matrix V(f,t) \tilde{H}^{H}(f,t). The precoding matrix unit 104 determines the RAIT precoder matrix, W_{RAIT,EIG}(f,t) based on the processed channel matrix.

Compared to the legacy precoder calculation algorithm of W_{RAIT}(f,t) that requires the inversion of an M×M matrix, the proposed algorithm computes a channel pre-processing matrix V(f,t) using K Eigen vectors and Eigen values of the interference covariance matrix, and involves inversion of a typically much smaller L×L matrix. The algorithm computes the precoder W_{RAIT,EIG}(f,t) using the processed channel matrix V(f,t) HH (f,t) and inversion of the L×L matrix \tilde{H}(f,t) V(f,t)\tilde{H}^{H}(ft)+δ²I_{L}.

### Numerical Simulations

The performance of the proposed beam reduction technique using numerical simulations of an example TDD system with a 36 MHz bandwidth, a subcarrier spacing of 30 KHz, and a carrier frequency 3.5 GHz is shown in FIG. 9. The simulation is for a multicell deployment scenario with 3 sites and 3 cells per site where the inter-site distance is 200 m and 36 WDs 22, each WD 22 equipped with 4 antennas, are randomly dropped in the simulation area. The 5G spatially correlated model Urban Macro channel model with non-line of sight communication is used. The antenna configuration at the base station is the active antenna system (AAS) 4×8×2 configuration. The traffic model for the downlink is selected as full buffer. The channel estimates are obtained using a full band sounding reference signal which is transmitted by each WD 22 every 6 msec from one antenna port and antenna port switching is enabled, i.e., complete channel information is obtained from all ports every 24 msec. The interference covariance matrix for each cell is estimated from the difference between the received sounding reference signal (SRS) and the reconstructed signal corresponding to SRS transmission from cell attached WDs 22 residuals.

FIG. 9 shows the average downlink cell throughput for the proposed method versus the number of eigen vectors used in computing the channel pre-processing matrix V(f,t). FIG. 9 also shows the downlink cell throughput using the RAT precoder which does not have any out-of-cell interference suppression capability. FIG. 9 shows that as the number of eigen vectors increases, the downlink cell throughput improves as the interference rejection capability improves. Note that using K=48 eigen vectors achieves the full dimension interference rejection capability of the full dimension RAIT algorithm (which corresponds to selecting K=64). Furthermore, FIG. 9 shows that using a smaller number of eigen vectors may still provide significant improvement in cell throughput over RAT beamforming, e.g., using K=24 eigen vectors achieves 50% of the performance gain (over RAT beamforming) achieved by full dimension RAIT.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AAS | Active Antenna Systems |
| MIMO | Multiple Input Multiple Output |
| MMSE | Minimum Mean Square Error |
| RAT | Reciprocity-Aided Transmission |
| RAIT | Reciprocity-Aided Interference Aware Transmission |
| SLNR | Signal to Leakage-plus-Noise Ratio |
| TDD | Time Domain Duplex |
| UE | User Equipment |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to determine a reciprocity-aided interference aware transmission, RAIT, precoder matrix for precoding downlink transmissions to a wireless, WD, the method comprising:
determining an L×M channel matrix by one of:
selecting L rows of an N×M channel matrix; and
selecting L linear combinations of rows of the N×M channel matrix,
M being a number of antennas at the network node to be used for the downlink transmissions, N being a number of receiving antennas at the WD, L being an integer less than M;
determining an M×M preprocessing matrix based at least in part on an eigen-decomposition of an M×M interference covariance matrix; and
determining an M×L RAIT precoder matrix based at least in part on an inverse of an L×L matrix, the L×L matrix being based at least in part on a first matrix product of the L×M channel matrix, the M×M preprocessing matrix and an M×L Hermitian transpose of the L×M channel matrix.

2. The method of claim 1, further comprising determining an M×M eigenvector matrix and M associated eigenvalues based at least in part on the eigen-decomposition of the M×M interference covariance matrix, each of the M associated eigenvalues being representative of an interference power and each eigenvector of the M×M eigenvector matrix being representative of a different direction of propagation of the interference power.

3. The method of claim 2, wherein the M×M preprocessing matrix is based at least in part on an estimated noise power associated with a subset of M−K eigenvectors of the M×M interference covariance matrix, K being an integer less than M.

4. The method of claim 3, wherein the estimated noise power per dimension is based at least in part on a difference between a first trace of the M×M interference covariance matrix and a second trace of a K×K diagonal matrix of eigenvalues corresponding to K selected eigenvectors of the M×M eigenvector matrix.

5. The method of claim 4, wherein the K selected eigenvectors are selected so that a sum of the corresponding eigenvalues is a specified fraction of a total interference power.

6. The method of claim 4, wherein the K selected eigenvectors correspond to a set of K largest eigenvalues.

7. The method of claim 1, wherein L is a number of transmission layers less than or equal to the number of receiving antennas at the WD.

8. The method of claim 1, wherein the M×L RAIT precoder matrix is determined based at least in part on a second matrix product of the M×M preprocessing matrix, the M×L Hermitian transpose of the L×M channel matrix and the inverse of the L×L matrix.

9. The method of claim 1, wherein the M×M preprocessing matrix is based at least in part on a third matrix product of an M×K matrix of selected eigenvectors, a K×K diagonal modified eigenvalue matrix, and the K×M Hermitian transpose of the M×K selected eigenvector matrix, K being an integer less than M.

10. The method of claim 1, wherein the M×M preprocessing matrix is determined at least in part by computing:
$$V ( f , t ) = \overline{y} ( f , t ) {I}_{M} - \tilde{E} ( f , t ) \tilde{Y} ( f , t ) {\tilde{E}}^{H} ( f , t )$$
where V(f,t) is the M×M preprocessing matrix,
$$\overline{y} ( f , t ) = \frac{{δ}^{2}}{\overline{σ} ( f , t ) + {δ}^{2}} ,$$
I_{M} is an M×M identity matrix, \tilde{E}(f,t) is an M×K matrix of K selected eigenvectors from the eigen vectors of the M×M interference covariance matrix, \tilde{Y}(f,t) is a K×K diagonal matrix with the i^{th} element given by
$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} ,$$
δ² is a minimum mean square error regularization factor, σᵢ(f,t) is a noise power associated with the i^{th} eigenvector of the M×M interference covariance matrix,
$$\overline{σ} ( f , t ) = \frac{t r \{ Λ ( f , t ) \} - t r \{ \tilde{Σ} ( f , t ) \}}{M - K} ,$$
is an estimated noise power per dimension, tr{Λ(f,t)} is the trace of the interference covariance matrix and tr{\tilde{Σ}(f,t)} is the trace of a K×K matrix of dominant eigenvalues corresponding to the K selected eigenvectors.

11. A network node configured to determine a reciprocity-aided interference aware transmission, RAIT, precoder matrix for precoding downlink transmissions to a wireless, WD, the network node comprising processing circuitry configured to:
determine an L×M channel matrix by one of:
selecting L rows of an N×M channel matrix; and
selecting L linear combinations of rows of the N×M channel matrix;
M being a number of antennas at the network node to be used for the downlink transmissions, N being a number of receiving antennas at the WD, L being an integer less than M;
determine an M×M preprocessing matrix based at least in part on an eigen-decomposition of an M×M interference covariance matrix; and
determine an M×L RAIT precoder matrix based at least in part on an inverse of an L×L matrix, the L×L matrix being based at least in part on a first matrix product of the L×M channel matrix, the M×M preprocessing matrix and an M×L Hermitian transpose of the L×M channel matrix.

12. The network node of claim 11, wherein the processing circuitry is further configured to determine an M×M eigenvector matrix and M associated eigenvalues based at least in part on the eigen-decomposition of the M×M interference covariance matrix, each of the M associated eigenvalues being representative of an interference power and each eigenvector of the M×M eigenvector matrix being representative of a different direction of propagation of the interference power represented by the corresponding eigenvalue.

13. The network node of claim 12, wherein the M×M preprocessing matrix is based at least in part on an estimated noise power associated with a subset of M−K eigenvectors of the M×M eigenvector matrix, K being an integer less than M.

14. The network node of claim 13, wherein the estimated noise power per dimension is based at least in part on a difference between a first trace of the M×M interference covariance matrix and a second trace of a K×K diagonal matrix of eigenvalues corresponding to K selected eigenvectors of the M×M eigenvector matrix.

15. The network node of claim 14, wherein the K selected eigenvectors are selected so that a sum of the corresponding eigenvalues is a specified fraction of a total interference power.

16. The network node of claim 14, wherein the K selected eigenvectors correspond to a set of K largest eigenvalues.

17. The network node of claim 11, wherein L is a number of transmission layers less than or equal to the number of receiving antennas at the wireless device.

18. The network node of claim 11, wherein the M×L RAIT precoder matrix is determined based at least in part on a second matrix product of the M×M preprocessing matrix, the M×L Hermitian transpose of the L×M channel matrix and the inverse of the L×L matrix.

19. The network node of claim 11, wherein the M×M preprocessing matrix is based at least in part on a third matrix product of an M×K matrix of selected eigenvectors, a K×K diagonal modified eigenvalue matrix, and an K×M Hermitian transpose of the M×K eigenvector matrix, K being an integer less than M.

20. The network node of claim 11, wherein the M×M preprocessing matrix is determined at least in part by computing:
$$V ( f , t ) = \overline{y} ( f , t ) {I}_{M} - \tilde{E} ( f , t ) \tilde{Y} ( f , t ) {\tilde{E}}^{H} ( f , t )$$
where V(f,t) is the M×M preprocessing matrix,
$$\overline{y} ( f , t ) = \frac{{δ}^{2}}{\overline{σ} ( f , t ) + {δ}^{2}} ,$$
I_{M} is an M×M identity matrix, \tilde{E}(f,t) is an M×K matrix of K selected eigenvectors from the M×M interference covariance matrix, \tilde{Y}(f,t) is a K×K diagonal matrix with the i^{th} element given by
$${\tilde{Y}}_{i , i} ( f , t ) = \frac{{σ}_{i} ( f , t )}{{σ}_{i} ( f , t ) + {δ}^{2}} - \frac{\overline{σ} ( f , t )}{\overline{σ} ( f , t ) + {δ}^{2}} ,$$
δ² is a minimum mean square error regularization factor, σᵢ(f,t) is a noise power associated with the i^{th} eigenvector of the M×M interference covariance matrix,
$$\overline{σ} ( f , t ) = \frac{t r \{ Λ ( f , t ) \} - t r \{ \tilde{Σ} ( f , t ) \}}{M - K} ,$$
is an estimated noise power per dimension, tr{Λ(f,t)} is the trace of the interference covariance matrix and tr{\tilde{Σ}(f,t)} is the trace of a K×K matrix of dominant eigenvalues corresponding to the K selected eigenvectors.
